(19) United States
(12) Patent Application Publication
(10) Pub. No.: US 2020/0295490 A1
(43) Pub. Date: Sep. 17, 2020

(54) ONE-PIECE SOCKET CONTACT

(71) Applicant: SMITHS INTERCONNECT AMERICAS, INC., Kansas City, KS (US)

(72) Inventors: Arkady Shinder-Lerner, Framingham, MA (US); Steven Correra, Saint Johns, FL (US)

(21) Appl. No.: 16/816,945

(22) Filed: Mar. 12, 2020

Related U.S. Application Data
(60) Provisional application No. 62/817,408, filed on Mar. 12, 2019.

(51) Int. Cl. H01R 13/11; H01R 4/18

(52) U.S. Cl. CPC H01R 13/11; H01R 4/187

(57) ABSTRACT

The one-piece socket contact includes a body extending along a longitudinal axis and having a first end and a second opposite the first end. The second end defining a cavity therein and configured to receive a wire having a wire termination. The one-piece socket contact includes a ring configured to receive a pin contact. The one-piece socket contact includes one or more beams extending longitudinally between the ring and the first end of the body. The one or more beams having a radially inward facing curvature and being configured to engage with and apply pressure to the pin contact.

### CROSS REFERENCE TO RELATED APPLICATIONS

This application claims the benefit and priority of U.S. Provisional Application No. 62/817,408 titled “ONE-PIECE SOCKET CONTACT,” filed on Mar. 12, 2019, the entire contents of this application is hereby incorporated by reference herein.

### BACKGROUND

### 1. Field of the Invention

This specification relates to electrical contacts, and more particularly, to one-piece socket contacts.

### 2. Description of the Related Art

Electrical socket contacts are used to electrically couple a pin contact to a wire termination. Conventional electrical socket contacts come in two forms, a long service life form and a short service life form. Both forms suffer from several inherent drawbacks. The long service life form generally has an outer diameter of 2.4 times the outer diameter of the pin contact it is configured to couple with. The long service life form is typically expensive to build due to the large number of components. For example, hyperboloid socket contacts are constructed from a minimum of eight individual components. The long service life form is also rigid and is unable to compensate for misalignment with pin contacts. This misalignment, as well as high mating forces, causes damage to the socket contacts which in turn decreases their service life.

The short service life form generally has a split front round barrow to compensate for misalignment with pin contacts. However, the short service life form has poor durability. For example, the short service life form inherently creates a narrow force concentration on the pin contact which results in gold plating being stripped off of the electrical socket contact. Both forms of electrical socket contacts are also not designed to engage with wires sizes that are 40 AWG or smaller.

Thus, there is a need for an electrical socket contact that compensates for misalignment with mating pins, has satisfactory durability, can engage with fragile wire sizes that are 40 AWG or smaller, and can be manufactured from a minimum number of components.

### SUMMARY

In general, one aspect of the subject matter described in this specification may be embodied in a one-piece socket contact. The one-piece socket contact includes a body extending along a longitudinal axis and having a first end and a second opposite the first end. The second end defining a cavity therein and configured to receive a wire having a wire termination. The one-piece socket contact includes a ring configured to receive a pin contact. The one-piece socket contact includes one or more beams extending longitudinally between the ring and the first end of the body. The one or more beams having a radially inward facing curvature and being configured to engage with and apply pressure to the pin contact.

These and other embodiments may optionally include one or more of the following features. At least a portion of the one-piece socket contact may be plated with a conductive material. The one-piece socket contact may further include at least one aperture extending between the cavity and an outer surface of the body. The at least one aperture may be configured to allow soldering of the wire termination to the body. The at least one aperture may be configured to crimp the insulated portion of the wire to the body. The second end of the one-piece socket contact may be configured to receive a wire termination that is less than or equal to 40 AWG in size.

The one or more beams may be at least partially flexible. A portion of the body located adjacent to the second end may be configured to be crimped onto a portion of the wire. The ring may have an inner diameter larger than an outer diameter of the pin contact to compensate for misalignment between the one-piece socket contact and the pin contact. The ring may have a flared opening to compensate for misalignment between the one-piece socket contact and the pin contact. The second end may have a flared opening to facilitate easier entry of the wire termination into the cavity.

In another aspect, the subject matter may be embodied in a one-piece socket contact. The one-piece socket contact includes a body extending along a longitudinal axis and having a first end and a second end opposite the first end. The one-piece socket contact includes a solder tail coupled to the second and extending longitudinally away from the body. The one-piece socket contact includes a ring configured to receive a pin contact. The one-piece socket contact includes one or more beams extending longitudinally between the ring and the first end of the body. The one or more beams having a radially inward facing curvature and being configured to engage with and apply pressure to the pin contact.

In another aspect, the subject matter may be embodied in a one-piece solder cup contact. The one-piece solder cup contact includes a body extending along a longitudinal axis and having a first end and a second end opposite the first end. The second end defining a cavity therein and configured to receive a wire having a wire termination. The one-piece solder cup contact includes a pin contact coupled to the first end and extending longitudinally away from the body.

### BRIEF DESCRIPTION OF THE D WINGS

The features and advantages of the embodiments of the present disclosure will become more apparent from the detailed description set forth below when taken in conjunction with the drawings. Naturally, the drawings and their associated descriptions illustrate example arrangements within the scope of the claims and do not limit the scope of the claims. Reference numbers are reused throughout the drawings to indicate correspondence between referenced elements.

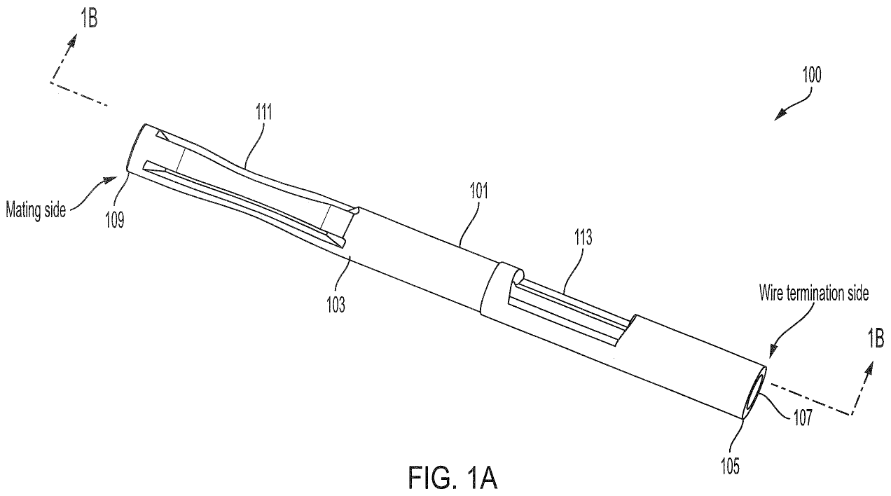

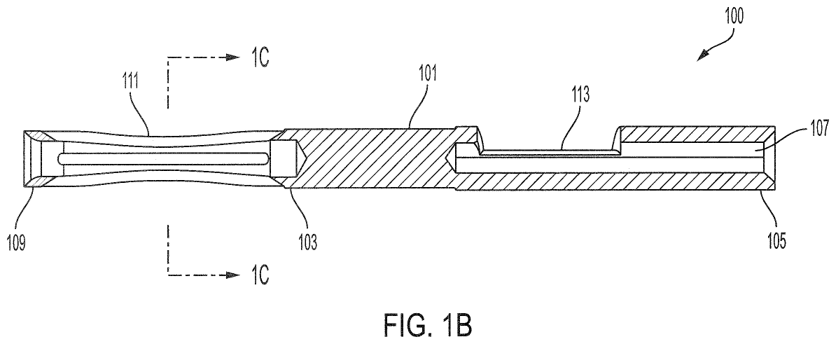

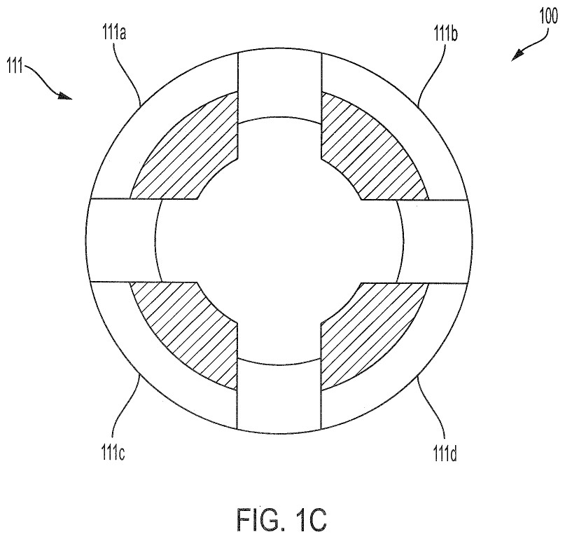

FIG. 1A is a perspective view of a one-piece socket contact according to an aspect of the invention.

FIG. 1B is a cross sectional view along line A-A in FIG. 1A of the one-piece socket contact shown in FIG. 1A.

FIG. 1C is a cross sectional view along line B-B in FIG. 1B of the one-piece socket contact shown in FIG. 1B.

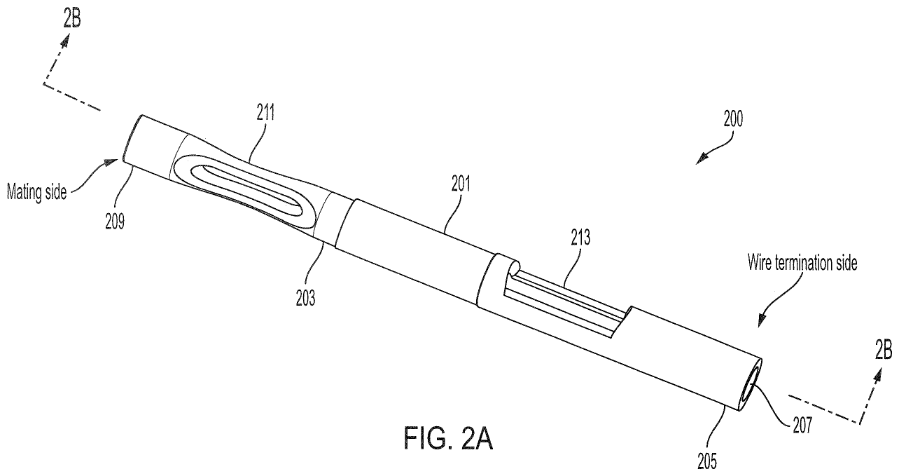

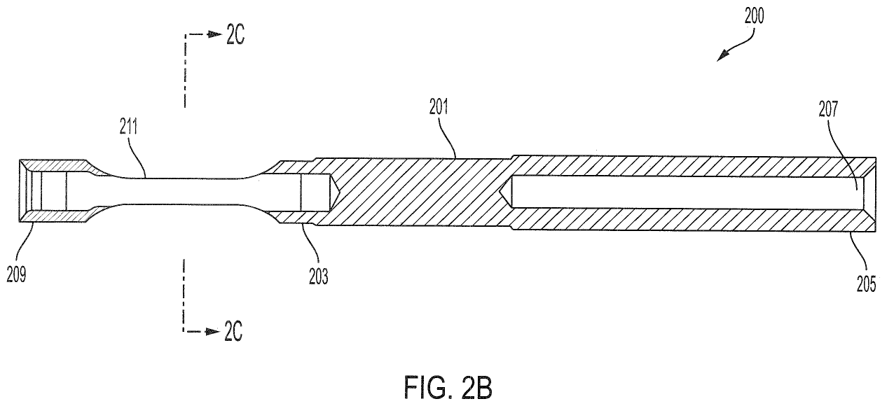

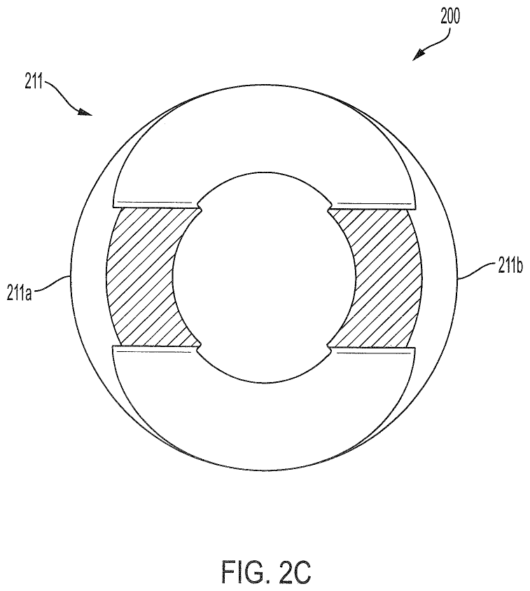

FIG. 2A is a perspective view of a one-piece socket contact according to an aspect of the invention.

FIG. 2B is a cross sectional view along line A-A in FIG. 2A of the one-piece socket contact shown in FIG. 2A.

FIG. 2C is a cross sectional view along line B-B in FIG. 2B of the one-piece socket contact shown in FIG. 2B.

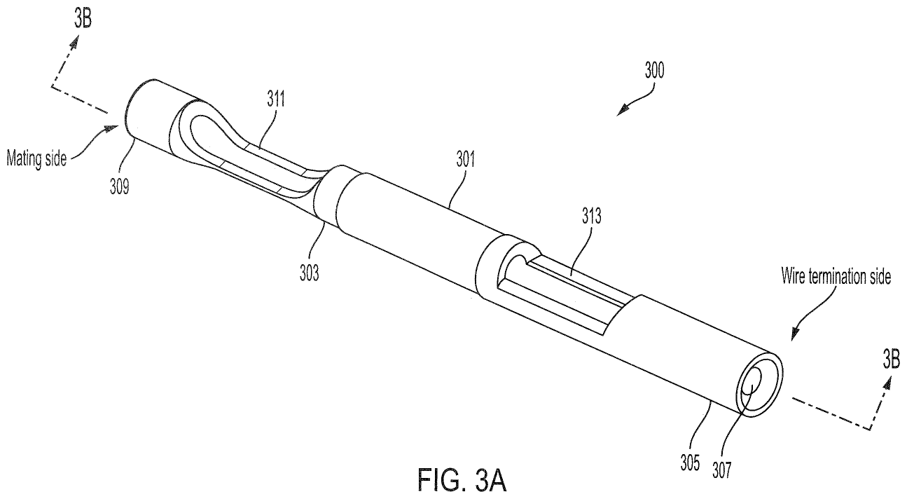

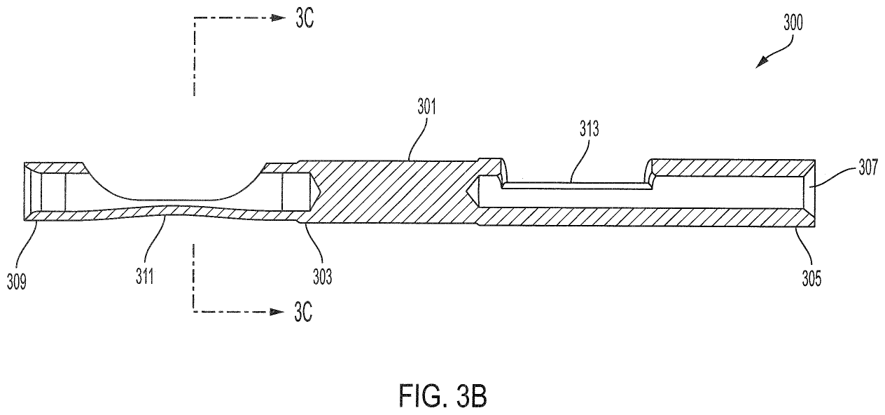

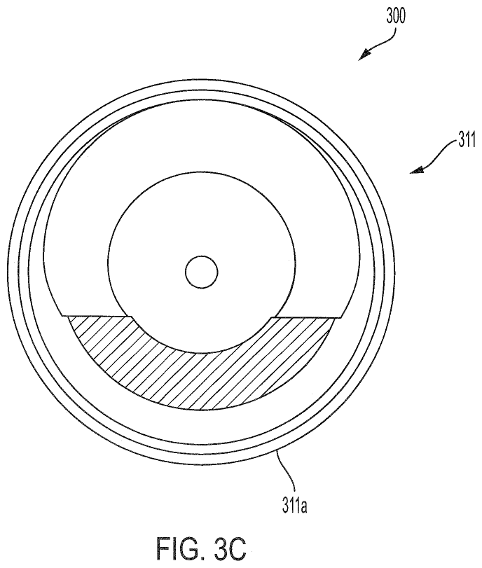

FIG. 3A is a perspective view of a one-piece socket contact according to an aspect of the invention.

FIG. 3B is a cross sectional view along line A-A in FIG. 3A of the one-piece socket contact shown in FIG. 3A.

FIG. 3C is a cross sectional view along line B-B in FIG. 3B of the one-piece socket contact shown in FIG. 3B.

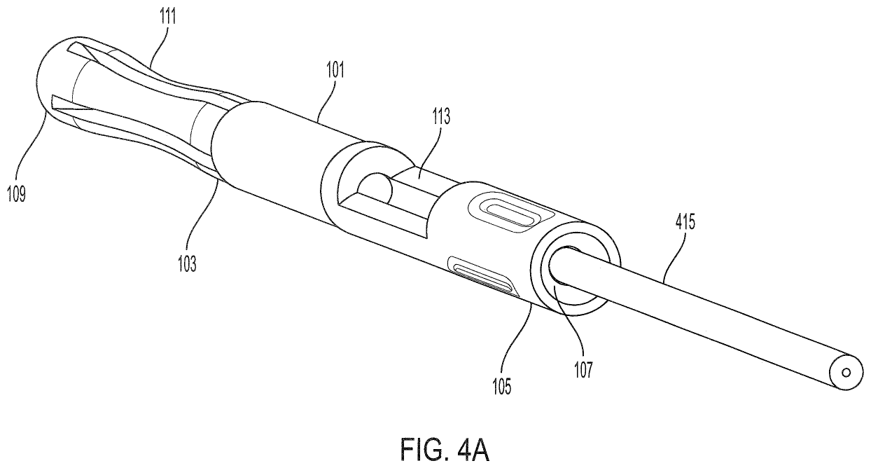

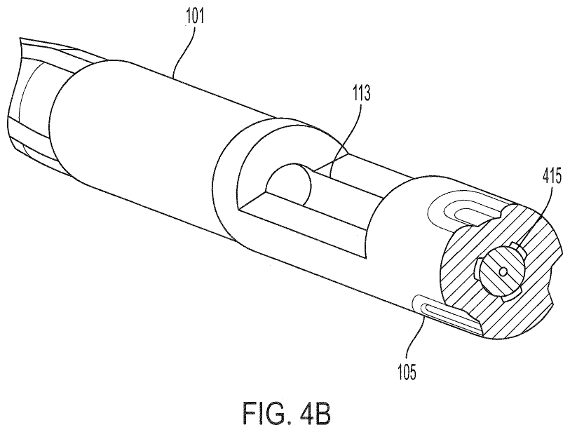

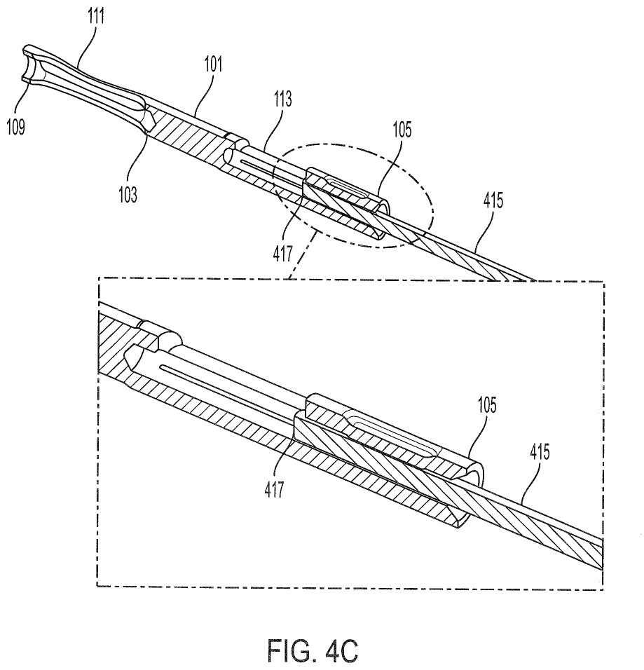

FIGS. 4A-4B show a perspective view of the one-piece socket contact of FIGS. 1A-1C and a wire according to an aspect of the invention.

FIG. 4C is a cross sectional view of the one-piece socket contact and the wire shown in FIGS. 4A-4B.

FIG. 5 shows a one-piece socket contact according to an aspect of the invention.

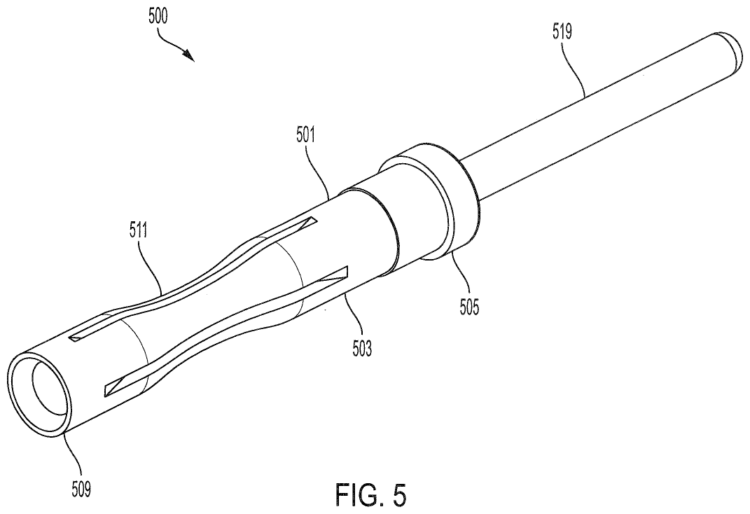

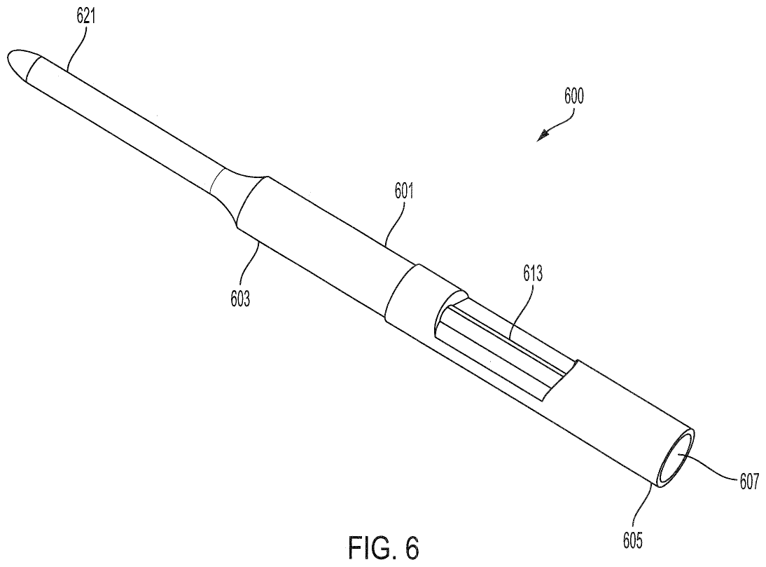

FIG. 6 shows a one-piece solder cup contact the pin according to an aspect of the invention.

### DETAILED DESCRIPTION

In the following detailed description, numerous specific details are set forth to provide an understanding of the present disclosure. It will be apparent, however, to one of ordinarily skilled in the art that elements of the present disclosure may be practiced without some of these specific details. In other instances, well-known structures and techniques have not been shown in detail to avoid unnecessarily obscuring the present disclosure.

FIG. 1A shows a one-piece socket (Arkaloid) contact 100. The one-piece socket contact 100 includes a body 101 extending along a longitudinal axis and having a first end 103 and a second end 105. The second end 105 defines a cavity 107 therein and is configured to receive a wire having a wire termination (as depicted in FIGS. 4A-4C). The one-piece socket contact 100 includes a ring 109 configured to receive a pin contact. The one-piece socket contact 100 includes one or more beams 111 extending longitudinally between the ring 109 and the first end 103 of the body 101. The one or more beams 111 have a radially inward facing curvature and are configured to engage with and apply pressure to the pin contact. The pressure on the pin contact may result from the radially inward facing curvature of the one or more beams 111 having an inner diameter that is smaller than an outside diameter of the pin contact.

The one-piece socket contact 100 is formed from a single piece of conductive spring material. For example, the one-piece socket contact 100 may be formed from a single piece of copper based spring alloy. However, other conductive spring materials may be used interchangeably according to various embodiments. At least a portion of the one-piece socket contact 100 may be plated with a conductive material. For example, the one-piece socket contact 100 may be plated with a non-oxidized metal. However, other conductive materials may be used interchangeably according to various embodiments.

The one or more beams 111 may be at least partially flexible. The flexibility of the one or more beams 111 may compensate for misalignment between the one-piece socket contact 100 and the pin contact. For example, the flexibility of the one or more beams 111 may allow for a pitch of less than or equal to 1.0 mm. However, the one or more beams 111 may be configured to allow other pitch distances interchangeably according to various embodiments.

In some embodiments, the one-piece socket contact 100 may include at least one aperture 113 extending between the cavity 107 and an outer surface of the body 101. The at least one aperture 113 may be configured to allow soldering of the wire to the body 101. The second end 105 may be configured to receive a wire termination that is less than or equal to 40 AWG in size. In some embodiments, a portion of the body 101 located adjacent to the second end 105 may be configured to be crimped onto a portion of the wire (as depicted in FIGS. 4A-4C). For example, a stripped portion of the wire (wire termination) may be soldered to the body 101 via the at least one aperture 113 and a portion of the body 101 located adjacent to the second end 105 may be crimped onto an insulated portion of the wire (as depicted in FIGS. 4A-4C). The soldered wire to the body 101 may facilitate electrical conductivity between the wire and the body 101 and the insulated portion of the wire under the crimp may facilitate mechanical durability to the soldered wire/body 101 pair.

The ring 109 may provide axial and radial stability to the one or more beams 111 from deformations in the axial and radial directions. The ring 109 may have an inner diameter larger than an outer diameter of the pin contact to compensate for misalignment between the one-piece socket contact 100 and the pin contact. In some embodiments, the ring 109 may have a flared opening to compensate for misalignment between the one-piece socket contact 100 and the pin contact. In some embodiments, the second end 105 may have a flared opening to facilitate easier entry of the wire termination into the cavity 107.

In some embodiments, the one-piece socket contact 100 may be at least partially formed by swaging. For example, the radially inward facing curvature of the one or more beams 111 may be formed by swaging after the body 101, the ring 109, and the one or more beams 111 have already been formed. In another example, the radially inward facing curvature of the one or more beams 111 may be formed by swaging before the body 101, the ring 109, and the one or more beams 111 have been formed. However, other manufacturing methods may be used interchangeably according to various embodiments.

FIG. 1B shows a cross sectional view along line A-A in FIG. 1A of the one-piece socket contact 100 shown in FIG. 1A. FIG. 1C shows a cross sectional view along line B-B in FIG. 1B of the one-piece socket contact 100 shown in FIG. 1B. FIG. 1C depicts the one or more beams 111 having four beams (111a, 111b, 111c, and 111d), however any number beams may be used interchangeably according to various embodiments.

FIG. 2A shows a one-piece socket (Arkaloid) contact 200. The one-piece socket contact 200 includes a body 201 extending along a longitudinal axis and having a first end 203 and a second end 205. The second end 205 defines a cavity 207 therein and is configured to receive a wire having a wire termination (as depicted in FIGS. 4A-4C). The one-piece socket contact 200 includes a ring 209 configured to receive a pin contact. The one-piece socket contact 200 includes one or more beams 211 extending longitudinally between the ring 209 and the first end 203 of the body 201. The one or more beams 211 have a radially inward facing curvature and are configured to engage with and apply pressure to the pin contact. The pressure on the pin contact may result from the radially inward facing curvature of the one or more beams 211 having an inner diameter that is smaller than an outside diameter of the pin contact.

The one-piece socket contact 200 is formed from a single piece of conductive spring material. For example, the one-piece socket contact 200 may be formed from a single piece of copper based spring alloy. However, other conductive spring materials may be used interchangeably according to various embodiments. At least a portion of the one-piece socket contact 200 may be plated with a conductive material. For example, the one-piece socket contact 200 may be plated with a conductive non-oxidized metal. However, other conductive materials may be used interchangeably according to various embodiments.

The one or more beams 211 may be at least partially flexible. The flexibility of the one or more beams 211 may compensate for misalignment between the one-piece socket contact 200 and the pin contact. For example, the flexibility of the one or more beams 211 may allow for a pitch of less than or equal to 1.0 mm. However, the one or more beams 211 may be configured to allow for other pitch distances interchangeably according to various embodiments.

In some embodiments, the one-piece socket contact 200 may include at least one aperture 213 extending between the cavity 207 and an outer surface of the body 201. The at least one aperture 213 may be configured to allow soldering of the wire to the body 201. The second end 205 may be configured to receive a wire termination that is less than or equal to 40 AWG in size. In some embodiments, a portion of the body 201 located adjacent to the second end 205 may be configured to be crimped onto an insulated portion of the wire (as depicted in FIGS. 4A-4C). For example, a stripped portion of the wire (wire termination) may be soldered to the body 201 via the at least one aperture 213 and a portion of the body 201 located adjacent to the second end 205 may be crimped onto an insulated portion of the wire (as depicted in FIGS. 4A-4C). The soldered wire to the body 201 may facilitate electrical conductivity between the wire and the body 201 and the insulated portion of the wire under the crimp may facilitate mechanical durability to the soldered wire/body 201 pair.

The ring 209 may provide axial and radial stability to the one or more beams 211 from deformations in the axial and radial directions. The ring 209 may have an inner diameter larger than an outer diameter of the pin contact to compensate for misalignment between the one-piece socket contact 200 and the pin contact. In some embodiments, the ring 209 may have a flared opening to compensate for misalignment between the one-piece socket contact 200 and the pin contact. In some embodiments, the second end 205 may have a flared opening to facilitate easier entry of the wire termination into the cavity 207.

In some embodiments, the one-piece socket contact 200 may be at least partially formed by swaging. For example, the radially inward facing curvature of the one or more beams 211 may be formed by swaging after the body 201, the ring 209, and the one or more beams 211 have already been formed. In another example, the radially inward facing curvature of the one or more beams 211 may be formed by swaging before the body 201, the ring 209, and the one or more beams 211 have been formed. However, other manufacturing methods may be used interchangeably according to various embodiments.

FIG. 2B shows a cross sectional view along line A-A in FIG. 2A of the one-piece socket contact 200 shown in FIG. 2A. FIG. 2C shows a cross sectional view along line B-B in FIG. 2B of the one-piece socket contact 200 shown in FIG. 2B. FIG. 2C depicts the one or more beams 211 having two beams (211a and 211b), however any number of beams may be used interchangeably according to various embodiments.

FIG. 3A shows a one-piece socket (Arkaloid) contact 300. The one-piece socket contact 300 includes a body 301 extending along a longitudinal axis and having a first end 303 and a second end 305. The second end 305 defines a cavity 307 therein and is configured to receive a wire having a wire termination (as depicted in FIGS. 4A-4C). The one-piece socket contact 300 includes a ring 309 configured to receive a pin contact. The one-piece socket contact 300 includes one or more beams 311 extending longitudinally between the ring 309 and the first end 303 of the body 301. The one or more beams 311 have a radially inward facing curvature and are configured to engage with and apply pressure to the pin contact. The pressure on the pin contact may result from the radially inward facing curvature of the one or more beams 311 having an inner diameter that is smaller than an outside diameter of the pin contact.

The one-piece socket contact 300 is formed from a single piece of conductive spring material. For example, the one-piece socket contact 300 may be formed from a single piece of copper based spring alloy. However, other conductive spring materials may be used interchangeably according to various embodiments. At least a portion of the one-piece socket contact 300 may be plated with a conductive material. For example, the one-piece socket contact 300 may be plated with a conductive non-oxidized metal. However, other conductive materials may be used interchangeably according to various embodiments.

The one or more beams 311 may be at least partially flexible. The flexibility of the one or more beams 311 may compensate for misalignment between the one-piece socket contact 300 and the pin contact. For example, the flexibility of the one or more beams 311 may allow for a pitch of less than or equal to 1.0 mm. However, the one or more beams 311 may be configured to allow for other pitch distances interchangeably according to various embodiments.

In some embodiments, the one-piece socket contact 300 may include at least one aperture 313 extending between the cavity 307 and an outer surface of the body 301. The at least one aperture 313 may be configured to allow soldering of the wire to the body 301. The second end 305 may be configured to receive a wire termination that is less than or equal to 40 AWG in size. In some embodiments, a portion of the body 301 located adjacent to the second end 305 may be configured to be crimped onto a portion of the wire (as depicted in FIGS. 4A-4C). For example, a stripped portion of the wire (wire termination) may be soldered to the body 301 via the at least one aperture 313 and a portion of the body 301 located adjacent to the second end 305 may be crimped onto an insulated portion of the wire (as depicted in FIGS. 4A-4C). The soldered wire to the body 301 may facilitate electrical conductivity between the wire and the body 301 and the insulated portion of the wire under the crimp may facilitate mechanical durability to the soldered wire/body 301 pair.

The ring 309 may provide axial and radial stability to the one or more beams 311 from deformations in the axial and radial directions. The ring 309 may have an inner diameter larger than an outer diameter of the pin contact to compensate for misalignment between the one-piece socket contact 300 and the pin contact. In some embodiments, the ring 309 may have a flared opening to compensate for misalignment between the one-piece socket contact 300 and the pin contact. In some embodiments, the second end 305 may have a flared opening to facilitate easier entry of the wire termination into the cavity 307.

In some embodiments, the one-piece socket contact 300 may be at least partially formed by swaging. For example, the radially inward facing curvature of the one or more beams 311 may be formed by swaging after the body 301, the ring 309, and the one or more beams 311 have already been formed. In another example, the radially inward facing curvature of the one or more beams 311 may be formed by swaging before the body 301, the ring 309, and the one or more beams 311 have been formed. However, other manufacturing methods may be used interchangeably according to various embodiments.

FIG. 3B shows a cross sectional view along line A-A in FIG. 3A of the one-piece socket contact 300 shown in FIG. 3A. FIG. 3C shows a cross sectional view along line B-B in FIG. 3B of the one-piece socket contact 300 shown in FIG. 3B. FIG. 3C depicts the one or more beams 311 having one beam 311a, however any number of one or more beams 311 may be used interchangeably according to various embodiments.

FIGS. 4A-4B show a perspective view of the one-piece socket (Arkaloid) contact 100 of FIGS. 1A-1C and a wire 415 according to an aspect of the invention. As shown, a portion of the body 101 located adjacent to the second end 105 is crimped onto an insulated portion of the wire 415.

FIG. 4C show a cross sectional view of the one-piece socket contact 100 and the wire 415 shown in FIGS. 4A-4B. The wire 415 has a stripped portion (wire termination end) 417 that is threaded into the cavity 107 and is accessible through the one or more apertures 113. The wire termination end 417 may be soldered to the body 101 of the one-piece socket contact 100 to allow conduction between a pin contact engaged with the ring 109 and the one or more beams 111 and the wire termination end 417.

FIG. 5 shows a one-piece socket (Arkaloid) contact 500 according to an aspect of the invention. The one-piece socket contact 500 includes a body 501 extending along a longitudinal axis and having a first end 503 and a second end 505. The one-piece socket contact 500 includes a solder tail 519 is coupled to the second end 505 and extends longitudinally away from the body 501. The one-piece socket contact 500 includes a ring 509 configured to receive a pin contact. The one-piece socket contact 500 includes one or more beams 511 extending longitudinally between the ring 509 and the first end 503 of the body 501. The one or more beams 511 have a radially inward facing curvature and are configured to engage with and apply pressure to the pin contact. The pressure on the pin contact may result from the radially inward facing curvature of the one or more beams 511 having an inner diameter that is smaller than an outside diameter of the pin contact.

The one-piece socket contact 500 is formed from a single piece of conductive spring material. For example, the one-piece socket contact 500 may be formed from a single piece of copper based spring alloy. However, other conductive spring materials may be used interchangeably according to various embodiments. At least a portion of the one-piece socket contact 500 may be plated with a conductive material. For example, the one-piece socket contact 500 may be plated with a conductive non-oxidized metal. However, other conductive materials may be used interchangeably according to various embodiments.

The one or more beams 511 may be at least partially flexible. The flexibility of the one or more beams 511 may compensate for misalignment between the one-piece socket contact 500 and the pin contact. For example, the flexibility of the one or more beams 511 may allow for a pitch of less than or equal to 1.0 mm. However, the one or more beams 511 may be configured to allow for other pitch distances interchangeably according to various embodiments.

The ring 509 may provide axial and radial stability to the one or more beams 511 from deformations in the axial and radial directions. The ring 509 may have an inner diameter larger than an outer diameter of the pin contact to compensate for misalignment between the one-piece socket contact 500 and the pin contact. In some embodiments, the ring 509 may have a flared opening to compensate for misalignment between the one-piece socket contact 500 and the pin contact.

FIG. 6 shows a one-piece solder cup contact 600 according to an aspect of the invention. The one-piece solder cup contact 600 includes a body 601 extending along a longitudinal axis and having a first end 603 and a second end 605. The second end 605 defines a cavity 607 therein and is configured to receive a wire having a wire termination (as similarly depicted in FIGS. 4A-4C). The one-piece solder cup contact 600 includes a pin contact 621 coupled to the first end 603 of the body 601.

The one-piece solder cup contact 600 is formed from a single piece of conductive material. For example, the one-piece solder cup contact 600 may be formed from a single piece of copper. However, other conductive materials may be used interchangeably according to various embodiments. At least a portion of the one-piece solder cup contact 600 may be plated with a conductive material. For example, the one-piece solder cup contact 600 may be plated with a conductive non-oxidized metal. However, other conductive materials may be used interchangeably according to various embodiments.

In some embodiments, the one-piece solder cup contact 600 may include at least one aperture 613 extending between the cavity 607 and an outer surface of the body 601. The at least one aperture 613 may be configured to allow soldering of the wire to the body 601. The second end 605 may be configured to receive a wire termination that is less than or equal to 40 AWG in size. In some embodiments, a portion of the body 601 located adjacent to the second end 605 may be configured to be crimped onto an insulating portion of the wire (as similarly depicted in FIGS. 4A-4C). For example, a stripped portion of the wire (wire termination) may be soldered to the body 601 via the at least one aperture 613 and a portion of the body 601 located adjacent to the second end 605 may be crimped onto an insulated portion of the wire (as depicted in FIGS. 4A-4C). The soldered wire to the body 601 may facilitate electrical conductivity between the wire and the body 601 and the insulated portion of the wire under the crimp may facilitate mechanical durability to the soldered wire/body 601 pair. In some embodiments, the second end 605 may have a flared opening to facilitate easier entry of the wire termination into the cavity 607.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that scope shall not be restricted, except in light of the appended claims and their equivalents.

What is claimed is:

1. A one-piece socket contact comprising:
a body extending along a longitudinal axis and having a first end and a second end opposite the first end, the second end defining a cavity therein and configured to receive a wire having a wire termination;
a ring configured to receive a pin contact; and
one or more beams extending longitudinally between the ring and the first end of the body, the one or more beams having a radially inward facing curvature and being configured to engage with and apply pressure to the pin contact.

2. The one-piece socket contact of claim 1, wherein at least a portion of the one-piece socket contact is plated with a conductive material.

3. The one-piece socket contact of claim 1, further comprising at least one aperture extending between the cavity and an outer surface of the body and configured to allow soldering of the wire termination to the body.

4. The one-piece socket contact of claim 3, wherein the second end is configured to receive a wire termination that is less than or equal to 40 AWG in size.

5. The one-piece socket contact of claim 4, wherein the one or more beams are at least partially flexible.

6. The one-piece socket contact of claim 5, wherein a portion of the body located adjacent to the second end is configured to be crimped onto a portion of the wire.

7. The one-piece socket contact of claim 6, wherein the ring has an inner diameter larger than an outer diameter of the pin contact to compensate for misalignment between the one-piece socket contact and the pin contact.

8. The one-piece socket contact of claim 6, wherein the ring has a flared opening to compensate for misalignment between the one-piece socket contact and the pin contact.

9. The one-piece socket contact of claim 8, wherein the second end has a flared opening to facilitate easier entry of the wire termination into the cavity.

10. A one-piece socket contact comprising:
a body extending along a longitudinal axis and having a first end and a second end opposite the first end;
a solder tail coupled to the second end and extending longitudinally away from the body;
a ring configured to receive a pin contact; and
one or more beams extending longitudinally between the ring and the first end of the body, the one or more beams having a radially inward facing curvature and being configured to engage with and apply pressure to the pin contact.

11. The one-piece socket contact of claim 10, wherein at least a portion of the one-piece socket contact is plated with a conductive material.

12. The one-piece socket contact of claim 10, wherein the one or more beams are at least partially flexible.

13. The one-piece socket contact of claim 12, wherein the ring has an inner diameter larger than an outer diameter of the pin contact to compensate for misalignment between the one-piece socket contact and the pin contact.

14. The one-piece socket contact of claim 12, wherein the ring has a flared opening to compensate for misalignment between the one-piece socket contact and the pin contact.

15. A one-piece solder cup contact comprising:
a body extending along a longitudinal axis and having a first end and a second end opposite the first end, the second end defining a cavity therein and configured to receive a wire having a wire termination; and
a pin contact coupled to the first end and extending longitudinally away from the body.

16. The one-piece solder cup contact of claim 15, wherein at least a portion of the one-piece solder cup contact is plated with a conductive material.

17. The one-piece solder cup contact of claim 15, further comprising at least one aperture extending between the cavity and an outer surface of the body and configured to allow soldering of the wire termination to the body.

18. The one-piece solder cup contact of claim 17, wherein the second end is configured to receive a wire termination that is less than or equal to 40 AWG in size.

19. The one-piece solder cup contact of claim 18, wherein a portion of the body located adjacent to the second end is configured to be crimped onto a portion of the wire.

20. The one-piece solder cup contact of claim 19, wherein the second end has a flared opening to facilitate easier entry of the wire termination into the cavity.
